(19) United States
(12) Patent Application Publication
(10) Pub. No.: US 2026/0110197 A1
(43) Pub. Date: Apr. 23, 2026

(54) DOOR LATCH APPARATUS FOR VEHICLE

(71) Applicant: PHA CO., LTD., Daegu (KR)

(72) Inventors: DONG HYEON KIM, Daegu (KR); NIGEL SPURR, Telford (GB)

(21) Appl. No.: 19/342,142

(22) Filed: Sep. 26, 2025

(30) Foreign Application Priority Data
Oct. 23, 2024 (KR) 10-2024-0146202

(51) Int. Cl. E05B 81/16; E05B 81/06; E05B 81/20; E05B 81/66

(52) U.S. Cl. CPC E05B 81/16; E05B 81/06; E05B 81/20; E05B 81/66

(57) ABSTRACT

The present invention relates to a door latch apparatus for a vehicle, and there is provided a door latch apparatus for a vehicle, which includes a base, a driving unit provided on the base, a latch unit provided on the base to control opening or closing of a door, a sector gear unit rotated by the driving unit, an opening operation unit configured to open the latch unit by rotation of the sector gear unit in one direction, a cinching operation unit configured to switch the latch unit to a completely locked state by rotation of the sector gear unit in the other direction, and a control part configured to detect positions of the opening operation unit and the cinching operation unit to detect a malfunction.

### CROSS-REFERENCE TO RELATED APPLICATION

This application claims priority to and the benefit of Korean Patent Application No. 10-2024-0146202, filed on October 23, 2024, the disclosure of which is incorporated herein by reference in its entirety.

### BACKGROUND

### Field of the Invention

The present invention relates to a door latch apparatus for a vehicle, and more specifically, to a door latch apparatus for a vehicle in which may integrate a power release function and a power cinching function are integrated and which detects a malfunction through position detection according to each function.

### Discussion of Related Art

A vehicle has a door latch for locking a door. Generally, the door latch has a catch that restrains a striker provided on a vehicle body, a pawl that restrains the catch, a release cable that is pulled when a door handle is pulled, and a release lever that rotates the pawl to release the restraint of the catch by the pawl when the release cable is pulled.

With this configuration, when the door is closed, the striker is inserted into a groove of the catch, the catch rotates in one direction, and the pawl blocks the catch from rotating in a reverse direction, thereby locking the door. When the handle is pulled in a closed state of the door, the restraint of the catch by the pawl is released as described above, thereby unlocking the door. That is, the locking of the door is released.

Recently, in order to enhance convenience, electric door latch apparatuses having power cinching and power release functions that lock and unlock the door by rotating the catch and the pawl with power of an electric motor have been applied to vehicles. However, conventional electric door latch apparatuses include a cinching actuator having an electric motor for performing a power cinching function and a release actuator having an electric motor for performing a power release function. Accordingly, the electric door latch apparatus is heavy, requires a large installation space, and also has an increased manufacturing cost.

The background technology of the present invention is disclosed in Korean Patent Registration No. 10-0736977 (registered on July 2, 2007, title: Power latch system).

### SUMMARY OF THE INVENTION

The present invention is directed to providing a door latch apparatus for a vehicle, which is capable of performing a power release function and a cinching function by a single driving unit.

The present invention is directed to providing a door latch apparatus for a vehicle, which is capable of detecting malfunctions of a power release function and a power cinching function through a plurality of Hall sensors.

According to the present invention, there is provided a door latch apparatus for a vehicle, which includes a base, a driving unit provided on the base, a latch unit provided on the base to control opening or closing of a door, a sector gear unit rotated by the driving unit, an opening operation unit configured to open the latch unit by rotation of the sector gear unit in one direction, a cinching operation unit configured to switch the latch unit to a completely locked state by rotation of the sector gear unit in the other direction, and a control part configured to detect positions of the opening operation unit and the cinching operation unit to detect a malfunction.

The latch unit may include a claw provided to be rotatable on the base, and a pawl that is attached to the claw and restrains a strike inserted into the claw.

The opening operation unit may include an operation protrusion formed on the sector gear unit, and a power drive lever that is in contact and rotated with the operation protrusion and rotates the pawl.

The cinching operation unit may include a cinching pawl pin connected to the sector gear unit, and a cinching operation lever that is in contact and rotated with the cinching pawl pin and moves the claw to a completely locked position when the sector gear unit rotates in the other direction.

The control part may include a first sensing unit configured to detect a position of the sector gear unit, a second sensing unit configured to detect a position of the claw, a third sensing unit configured to detect a position of the pawl, and a control unit configured to determine whether a defect is present based on detection values of the first sensing unit, the second sensing unit, and the third sensing unit.

The first sensing unit may include a first detection lever provided to be rotatable on the base, provided in contact and conjunction with the sector gear unit, and having magnets of N and S poles, and a first Hall element provided on the base and provided to correspond to the first detection lever.

The sector gear unit may include an operation plate, and the operation plate may have a catch protrusion formed in contact with the first detection lever.

A position of the first detection lever may be fixed by a position fixing unit, and the position fixing unit may include a fixing protrusion formed on the base, and a plurality of fixing grooves formed in the same trajectory centered on a center axis of the first detection lever to correspond to the fixing protrusion.

The second sensing unit may include a second detection lever provided to be rotatable on the base, provided in conjunction with rotation of the claw, and having magnets of N and S poles, and a second Hall element provided on the base and provided to correspond to the second detection lever.

The third sensing unit may include a third detection lever provided to be rotatable on the pawl and having magnets of N and S poles, and a third Hall element provided on the base and provided to correspond to the third detection lever.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view for describing a door latch apparatus for a vehicle according to one embodiment of the present invention;

FIG. 2 is an exploded perspective view for describing the door latch apparatus for a vehicle according to one embodiment of the present invention;

FIG. 3 is an exploded perspective view for describing the door latch apparatus for a vehicle according to one embodiment of the present invention in a different direction;

FIG. 4 is an exploded perspective view of main parts of the door latch apparatus for a vehicle according to one embodiment of the present invention;

FIG. 5 is a front view showing an internal configuration of the door latch apparatus for a vehicle according to one embodiment of the present invention;

FIG. 6 is a rear view showing the internal configuration of the door latch apparatus for a vehicle according to one embodiment of the present invention;

FIG. 7 is a front view for describing a power release operation of the door latch apparatus for a vehicle according to one embodiment of the present invention;

FIG. 8 is a rear view for describing the power release operation of the door latch apparatus for a vehicle according to one embodiment of the present invention;

FIG. 9 is a front view for describing a cinching operation of the door latch apparatus for a vehicle according to one embodiment of the present invention;

FIG. 10 is a rear view for describing the cinching operation of the door latch apparatus for a vehicle according to one embodiment of the present invention;

FIG. 11 is a front view for describing a de-clutch operation of the door latch apparatus for a vehicle according to one embodiment of the present invention;

FIG. 12 is a view for describing reconnection of a sector gear unit of the door latch apparatus for a vehicle according to one embodiment of the present invention;

FIG. 13 is a view showing position detection by the power release operation of the door latch apparatus for a vehicle according to one embodiment of the present invention; and

FIG. 14 is a view showing position detection by the cinching operation of the door latch apparatus for a vehicle according to one embodiment of the present invention.

### DETAILED DESCRIPTION OF EXEMPLARY EMBODIMENTS

Hereinafter, exemplary embodiments of a door latch apparatus for a vehicle according to one embodiment of the present invention will be described with reference to the accompanying drawings. In this description, thicknesses of lines, sizes of components, and the like shown in the drawings may be exaggerated for clarity and convenience of the description.

In addition, terms to be described below are the terms defined in consideration of functions in the present invention, which may be changed according to a user or operator’s intention or custom. Accordingly, the definition of these terms should be made based on the description throughout the present specification.

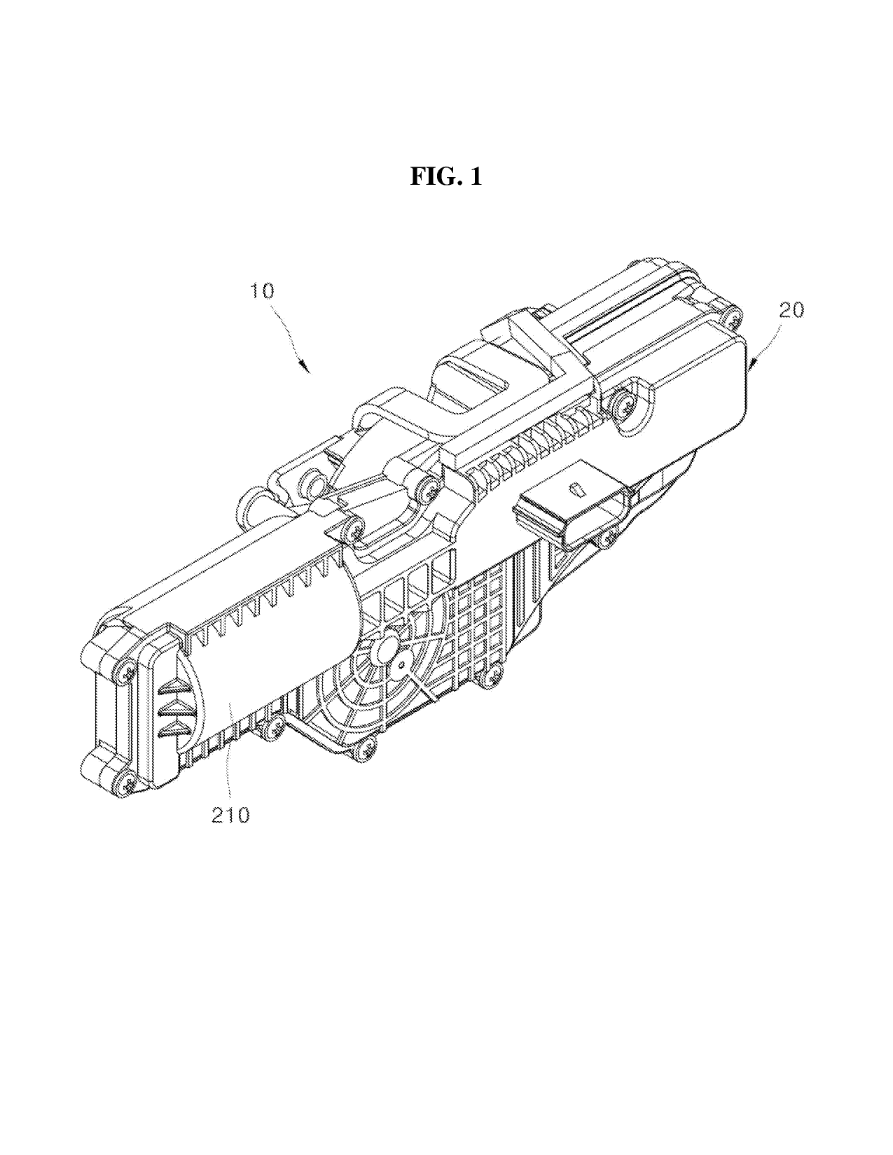

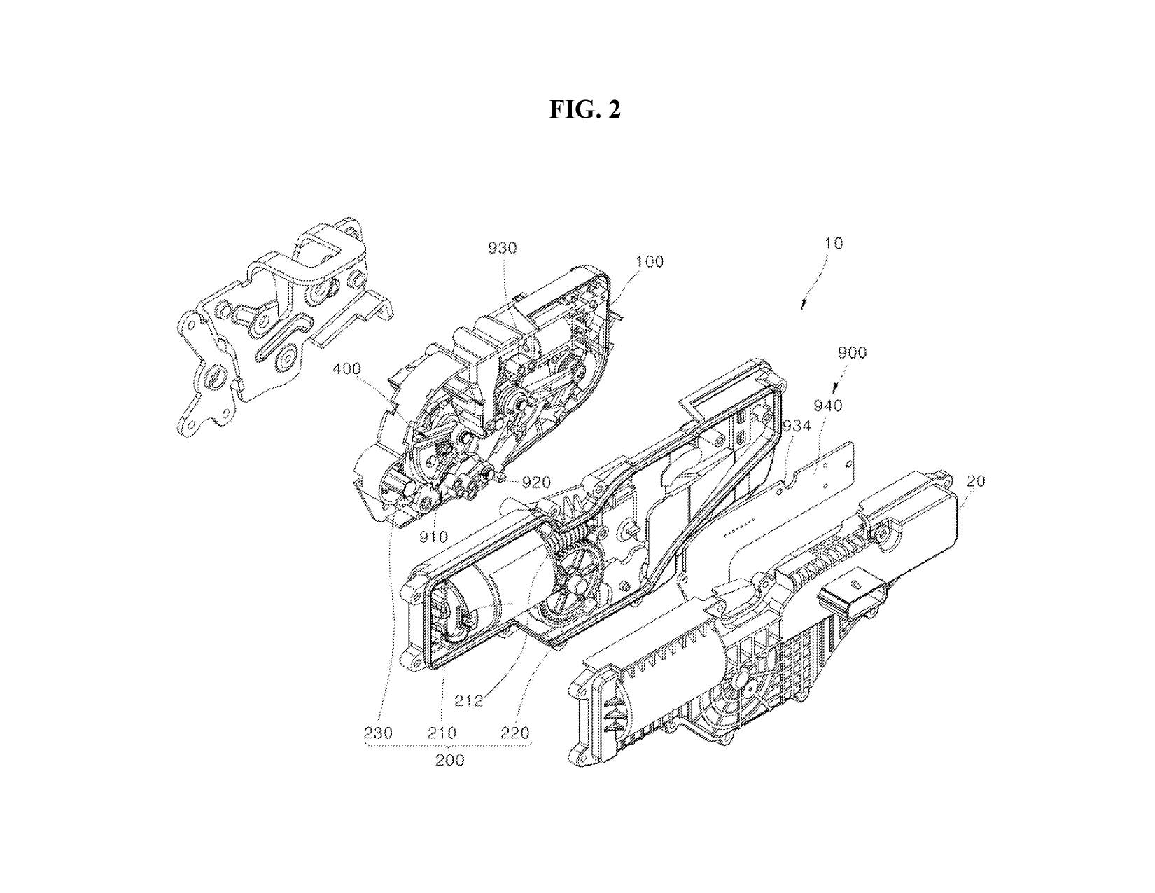

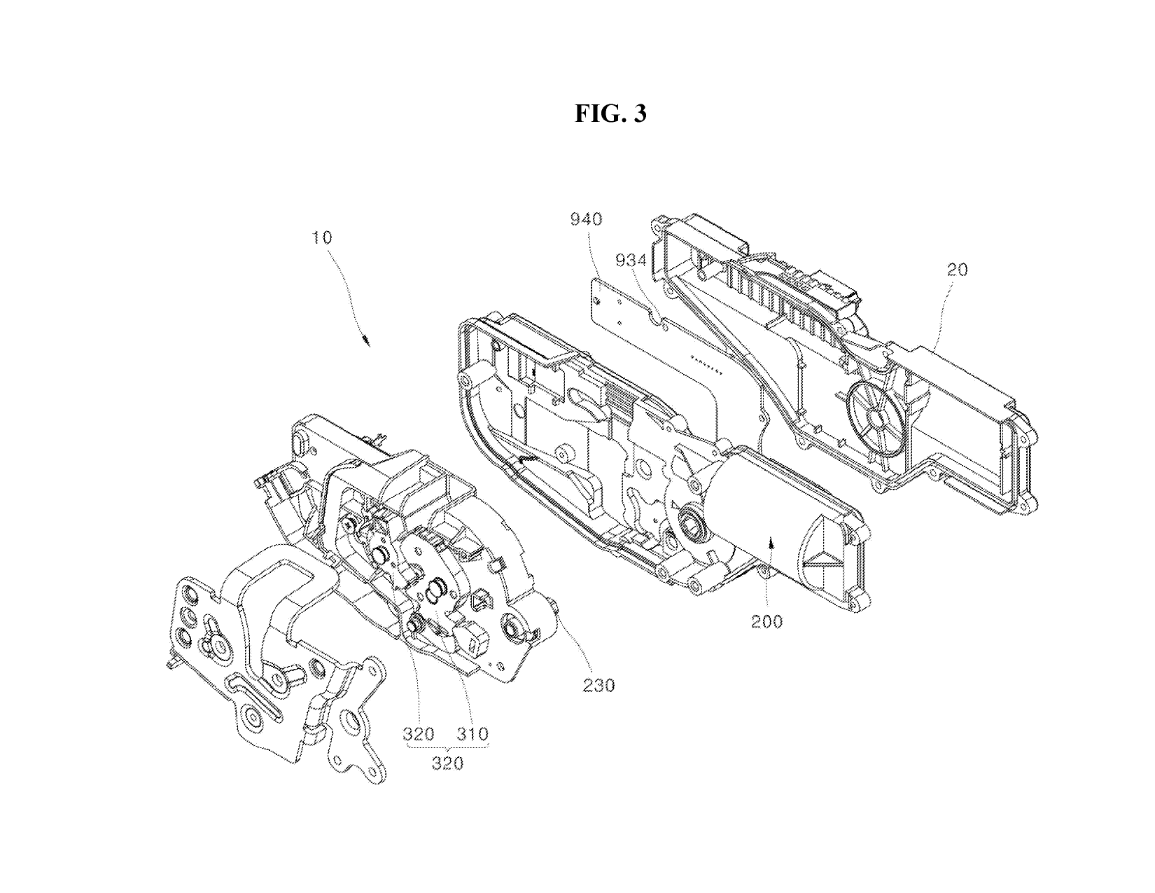

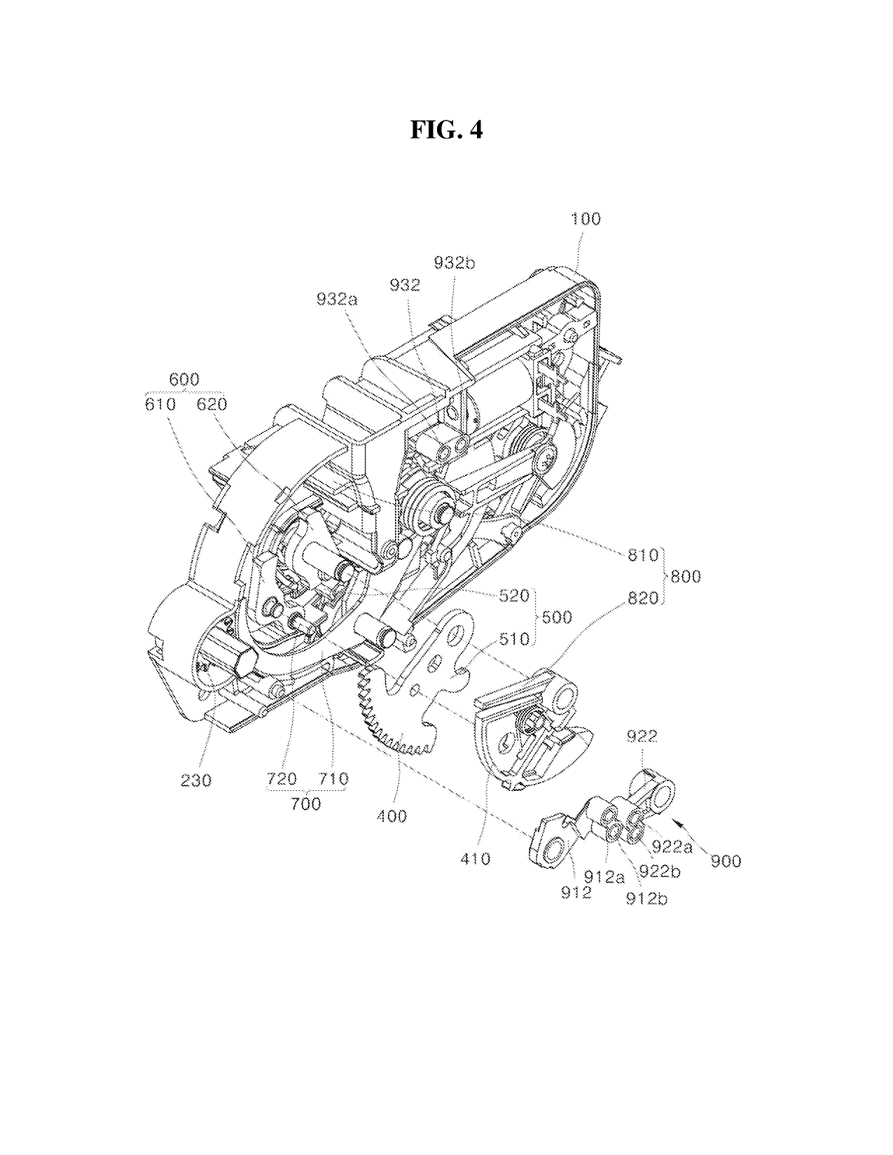

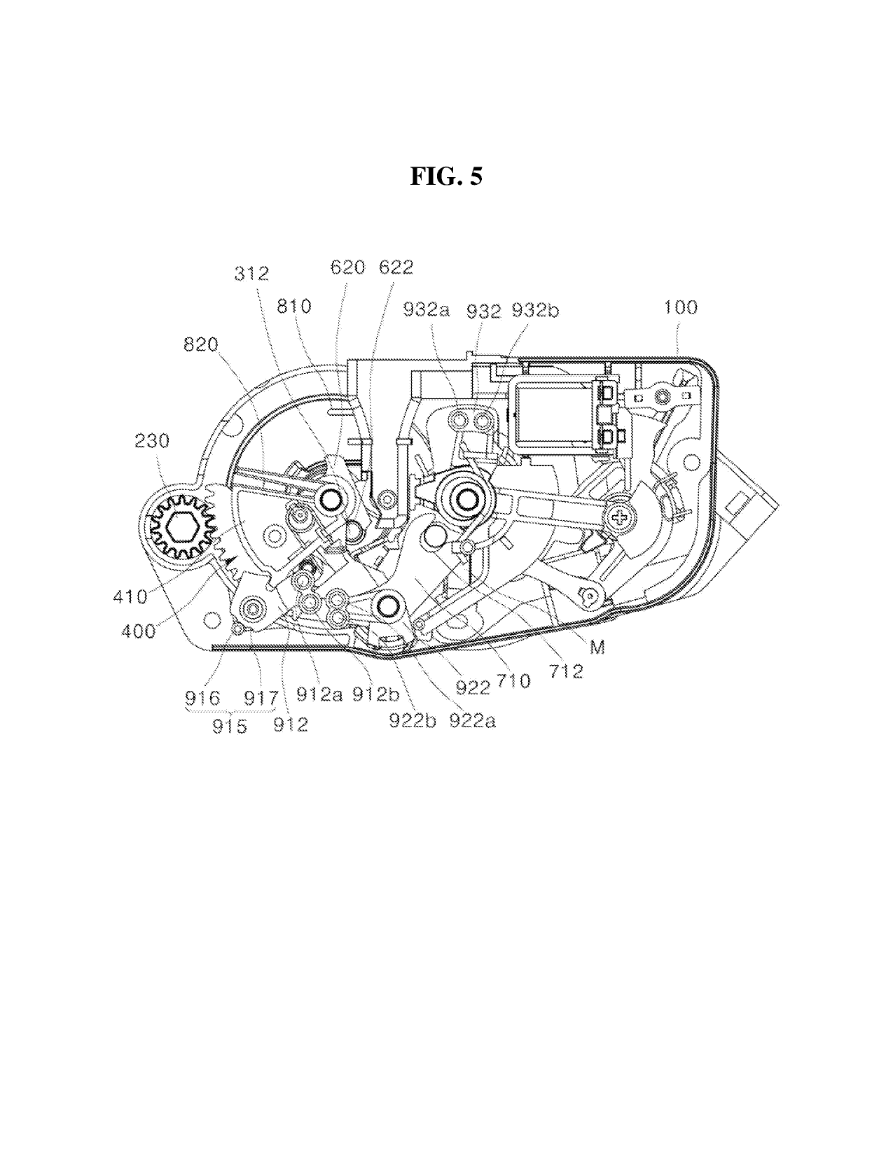

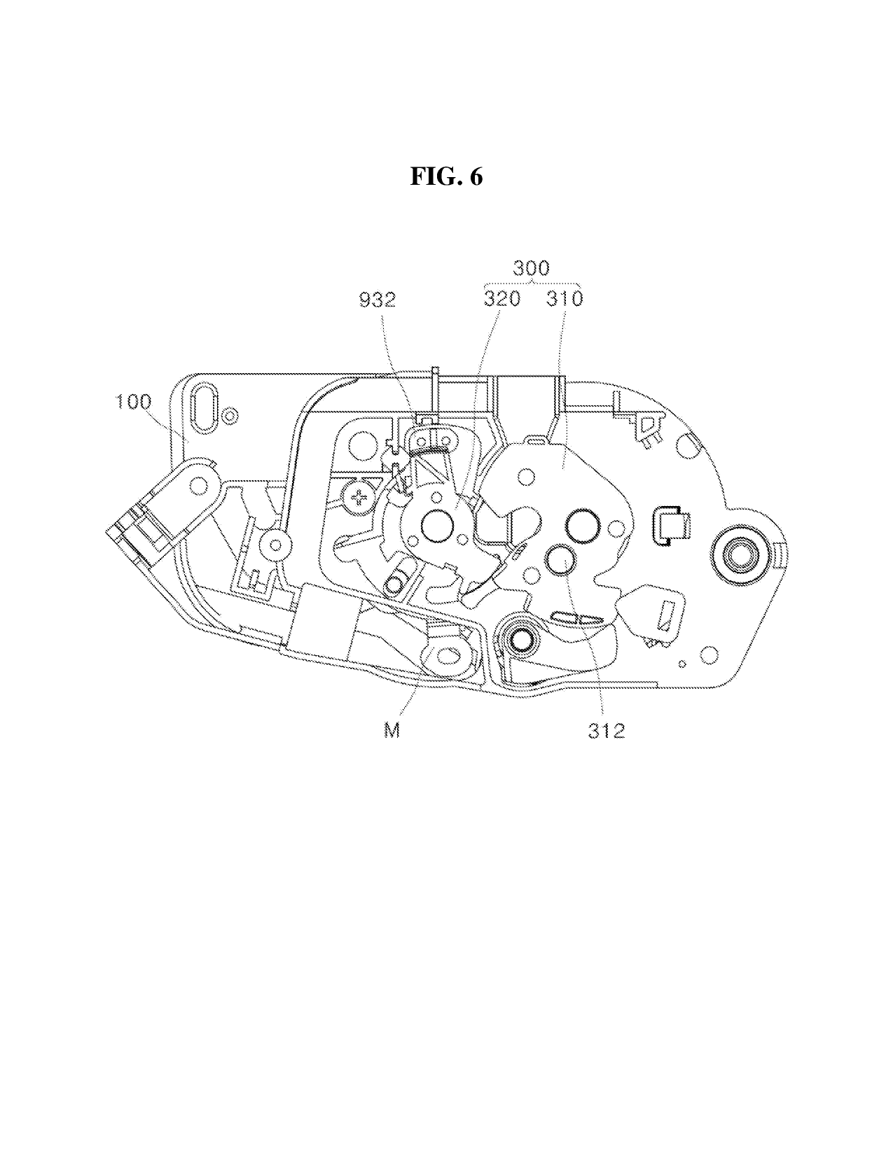

FIG. 1 is a perspective view for describing a door latch apparatus for a vehicle according to one embodiment of the present invention, FIG. 2 is an exploded perspective view for describing the door latch apparatus for a vehicle according to one embodiment of the present invention, FIG. 3 is an exploded perspective view for describing the door latch apparatus for a vehicle according to one embodiment of the present invention in a different direction, FIG. 4 is an exploded perspective view of main parts of the door latch apparatus for a vehicle according to one embodiment of the present invention, FIG. 5 is a front view showing an internal configuration of the door latch apparatus for a vehicle according to one embodiment of the present invention, and FIG. 6 is a rear view showing the internal configuration of the door latch apparatus for a vehicle according to one embodiment of the present invention.

Referring to FIGS. 1 to 6, a door latch apparatus 10 for a vehicle according to one embodiment of the present invention may include a base 100, a driving unit 200, a latch unit 300, a sector gear unit 400, an opening operation unit 500, and a cinching operation unit 600.

The base 100 is formed in a plate shape, and components are disposed in a link-connected manner. The base 100 may be disposed in a housing 20.

The driving unit 200 may be provided on the base 100 and serve as a component that provides power for operating the opening operation unit 500 and the cinching operation unit 600.

More specifically, the driving unit 200 may include a motor unit 210 that is provided on the base 100 and generates power, a release gear 220 that is engaged with an output power shaft of the motor unit 210, and a spur gear 230 that is provided to rotate on a concentric shaft of the release gear 220 and engaged with the sector gear unit 400 to be described below.

The output power shaft of the motor unit 210 may include a worm gear 212 engaged with the release gear 220.

The latch unit 300 may be provided on the base 100 to control the opening or closing of a door and include a claw 310 that is provided to rotate on the base 100 and a pawl 320 that is engaged with the claw 310 and restrains a strike inserted into the claw 310.

When the engagement of the claw 310 and the pawl 320 is released, the restraint of the strike may be released by the rotation of the claw 310.

The latch unit 300 may be provided on a surface opposite to a surface on which the sector gear unit 400, the opening operation unit 500, and the cinching operation unit 600 are provided. That is, as shown in FIGS. 2 and 3, the sector gear unit 400, the opening operation unit 500, and the cinching operation unit 600 may be provided on one surface of the base 100, and the latch unit 300 may be provided on the other surface.

The sector gear unit 400 may be provided to rotate on the base 100, rotated by the driving force of the driving unit 200 and perform an opening operation or a cinching operation depending on a direction of rotation of the sector gear unit 400. That is, the sector gear unit 400 may rotate in one direction and the opposite direction depending on the direction of rotation of the driving unit 200.

The sector gear unit 400 is a fan-shaped gear, and gear teeth formed on an outer surface thereof may be engaged with the spur gear 230 and rotate about a center axis.

The opening operation unit 500 may serve as a component that opens the latch unit 300 by the rotation of the sector gear unit 400 in one direction.

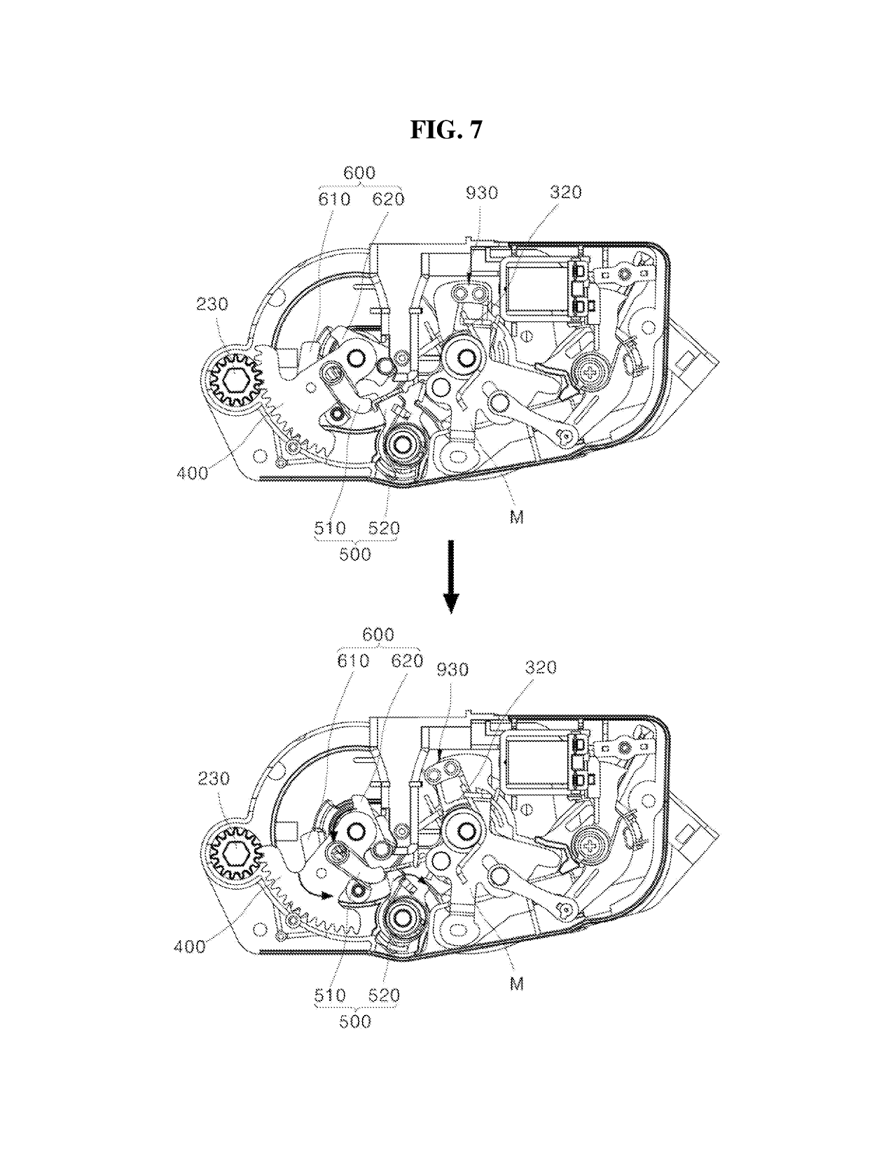

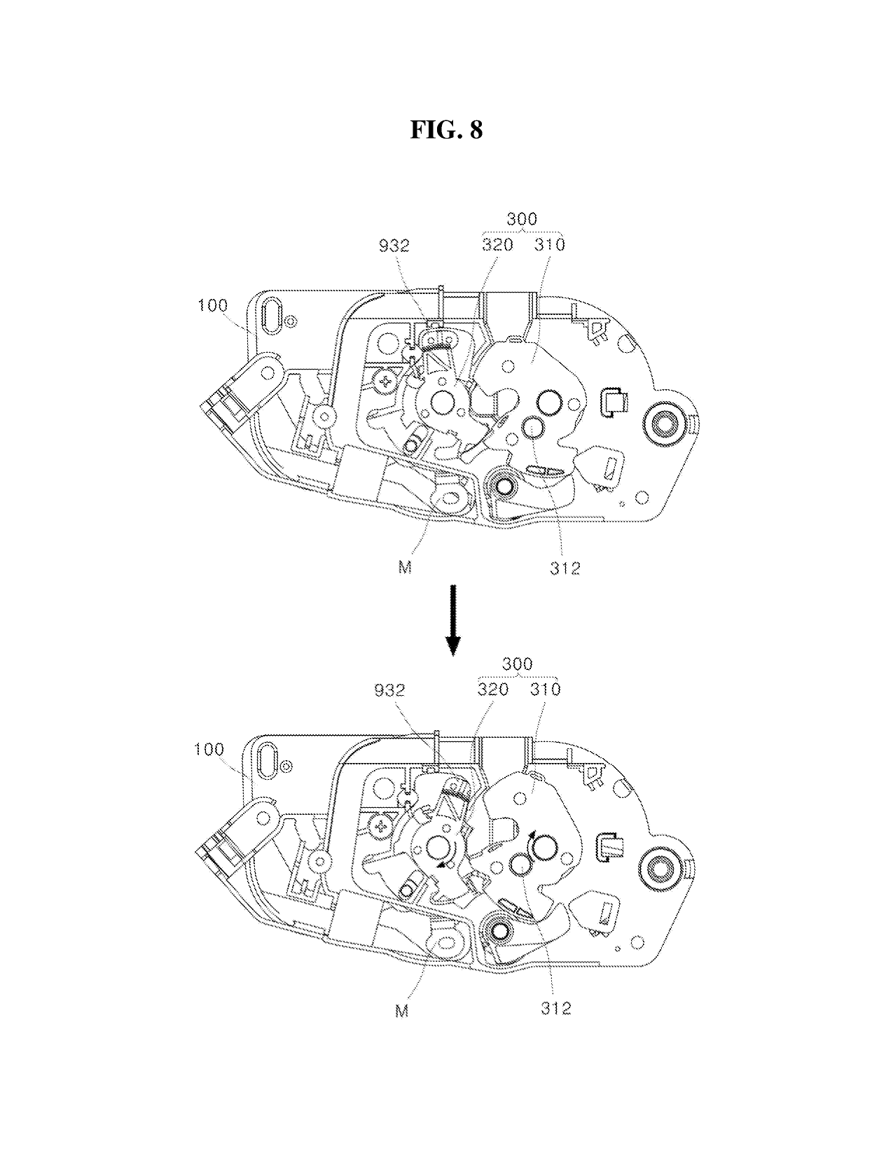

FIG. 7 is a front view for describing a power release operation of the door latch apparatus for a vehicle according to one embodiment of the present invention, and FIG. 8 is a rear view for describing the power release operation of the door latch apparatus for a vehicle according to one embodiment of the present invention.

Referring to FIGS. 1 to 8, the opening operation unit 500 may open the latch unit 300 by the rotation of the sector gear unit 400 in one direction.

Here, the rotation of the sector gear unit 400 in one direction is a counterclockwise rotation about the center axis of the sector gear unit 400 based on FIG. 7.

For example, the opening operation unit 500 may include an operation protrusion 510 formed on the sector gear unit 400 and a power drive lever 520 that is in contact and rotated with the operation protrusion 510 and rotates the pawl 320.

The operation protrusion 510 may be formed to protrude in an opening operation direction of the sector gear unit 400, and the power drive lever 520 may be formed to rotate on the base 100 and rotated by the contact of the operation protrusion 510 to rotate the pawl 320, thereby releasing the engagement of the claw 310 and the pawl 320.

The power drive lever 520 may be elastically supported by a torsion spring and returned to an initial position by an elastic force after being in contact with the pawl 320.

More specifically, the release gear 220 is rotated by the driving force of the motor unit 210, and the sector gear unit 400 engaged with the spur gear 230 is rotated counterclockwise by the rotation of the spur gear 230 rotated together with the release gear 220.

When the operation protrusion 510 is in contact with the power drive lever 520 by the rotation of the sector gear unit 400 to rotate the power drive lever 520, the power drive lever 520 may rotate the pawl 320 to release the engagement of the claw 310 and the pawl 320, thereby opening the latch unit 300.

The cinching operation unit 600 may serve as a component that switches the latch unit 300 to a completely locked state by the rotation of the sector gear unit 400 in the other direction.

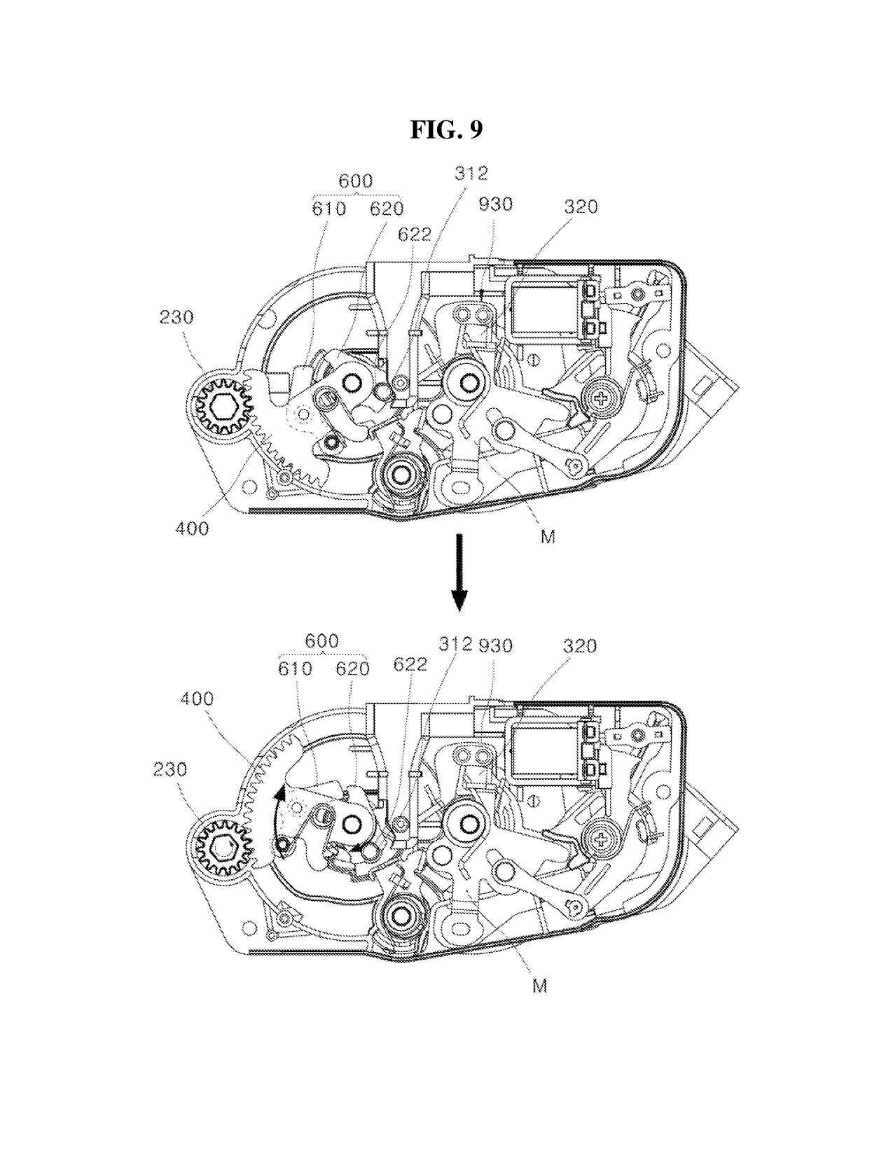

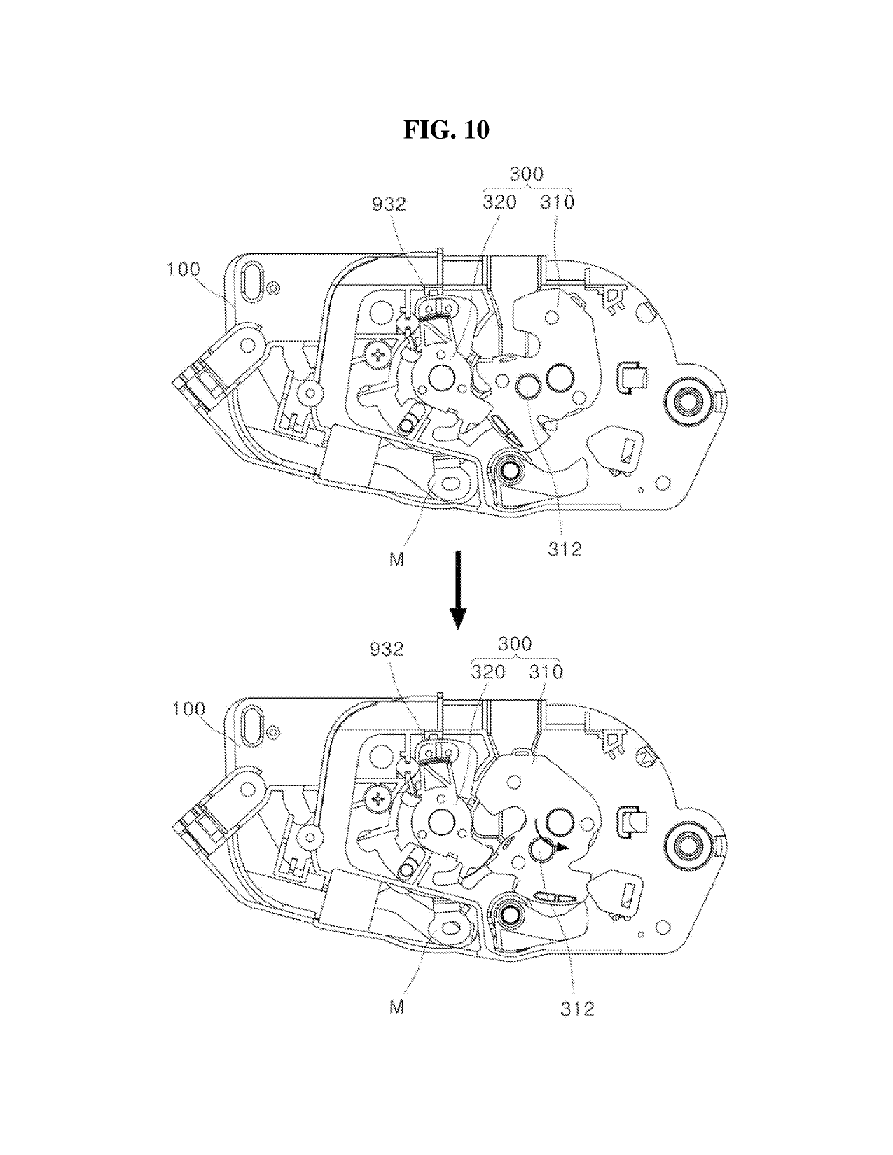

FIG. 9 is a front view for describing a cinching operation of the door latch apparatus for a vehicle according to one embodiment of the present invention, and FIG. 10 is a rear view for describing the cinching operation of the door latch apparatus for a vehicle according to one embodiment of the present invention.

Referring to FIGS. 1 to 6, 9, and 10, the cinching operation unit 600 may rotate the claw 310 by the rotation of the sector gear unit 400 in the other direction to switch the latch unit 300 to the completely locked state.

Here, the rotation of the sector gear unit 400 in the other direction is a clockwise rotation about the center axis of the sector gear unit 400 based on FIG. 9.

For example, the cinching operation unit 600 may include a cinching pawl pin 610 connected to the sector gear unit 400 and a cinching operation lever 620 that is in contact and rotated with the cinching pawl pin 610 and moves the claw 310 to a completely locked position when the sector gear unit 400 rotates in the other direction.

A central portion of the cinching pawl pin 610 is provided to rotate on the sector gear unit 400 and is formed to extend clockwise to be in contact with the cinching operation lever 620. In addition, the cinching pawl pin 610 may extend counterclockwise to form a contact pin 720 in contact with a de-clutch lever 710 to be described below.

The cinching operation lever 620 is provided to rotate on the center axis of the sector gear unit 400, and a catch groove 622 recessed in a circumferential surface thereof to be connected to a catch shaft 312 of the claw 310.

Accordingly, when the cinching pawl pin 610 is in contact with the cinching operation lever 620 by the clockwise rotation of the sector gear unit 400, the cinching operation lever 620 may be rotated, and the claw 310 may be rotated by the rotation of the cinching operation lever 620, thereby switching the claw 310 from a primarily locked state to the completely locked state.

In this case, the cinching pawl pin 610 in a clockwise rotated state may be maintained by the torsion spring.

The cinching operation unit 600 may further include a de-clutch unit 700 for stopping switching the claw 310 to the completely locked state.

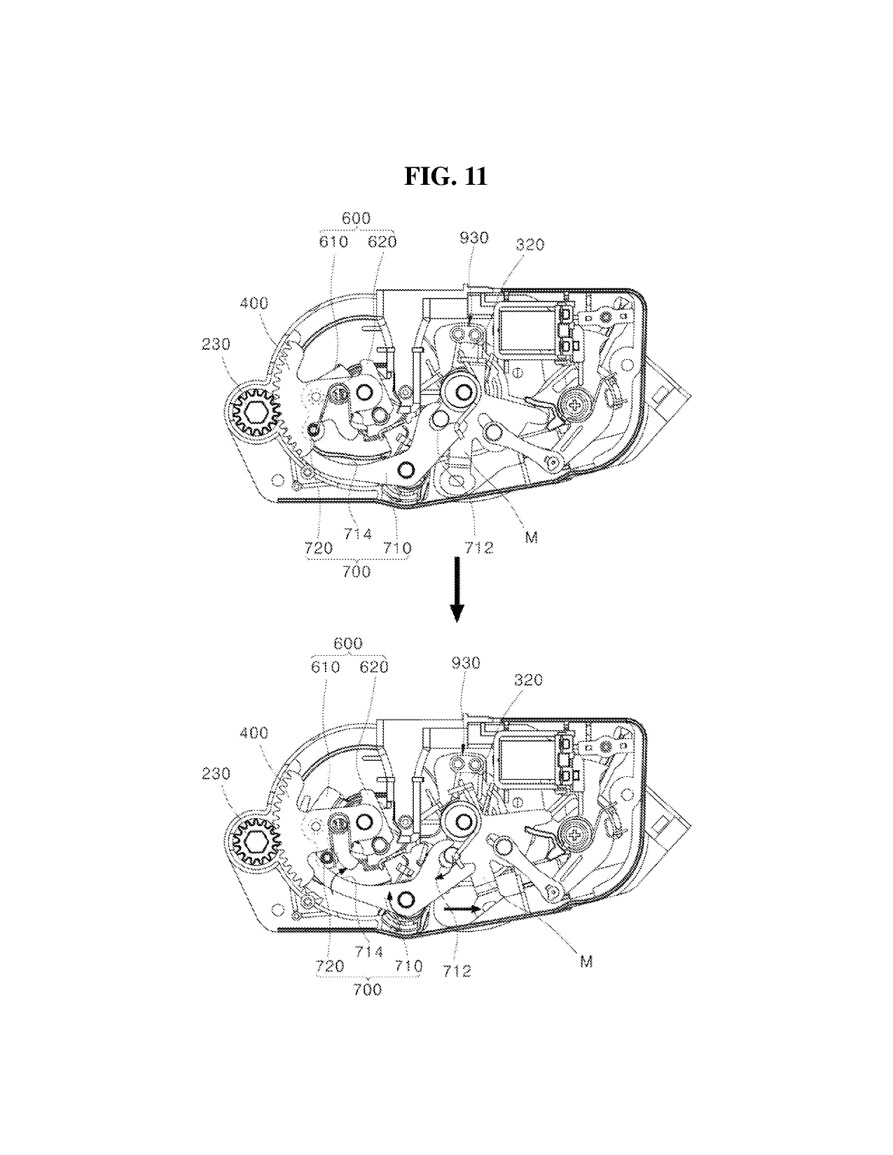

FIG. 11 is a front view for describing a de-clutch operation of the door latch apparatus for a vehicle according to one embodiment of the present invention.

Referring to FIGS. 1 to 6 and 11, the de-clutch unit 700 according to the present embodiment may include the de-clutch lever 710 and the contact pin 720.

The de-clutch lever 710 may be connected to a manual lever M and provided to rotate on the base 100. A central portion of the de-clutch lever 710 is pivotally coupled to the base 100 and provided to rotate.

The manual lever M may serve as a component that is connected to an inside lever (not shown) and an outside lever (not shown) by a wire to rotate the pawl 320 and release the engagement of the latch unit 300, thereby opening the door.

The contact pin 720 may serve as a component that is formed on the cinching pawl pin 610 to be in contact with the de-clutch lever 710 and rotates the cinching pawl pin 610 counterclockwise while in contact therewith, thereby preventing the cinching pawl pin 610 from being in contact with the cinching operation lever 620.

The contact pin 720 is formed on an opposite end portion facing the cinching operation lever 620 with respect to the central portion of the cinching pawl pin 610.

In addition, one end of the de-clutch lever 710 may have a connecting groove 712 connected to the manual lever M and the other end may include a curved portion 714 extending to be in contact with the contact pin 720 when the de-clutch lever 710 rotates.

Accordingly, when the de-clutch lever 710 is rotated by the rotation of the manual lever M during the cinching operation by the clockwise rotation of the sector gear unit 400, the curved portion 714 may be in contact with the contact pin 720 to prevent the rotation of the cinching pawl pin 610, thereby preventing the cinching pawl pin 610 from being in contact with the cinching operation lever 620 and preventing the cinching operation. Accordingly, it is possible to prevent the claw 310 from switching from the primarily locked state to the completely locked state.

The sector gear unit 400 may include a reconnector 800 that prevents connection of the spur gear 230 from being released.

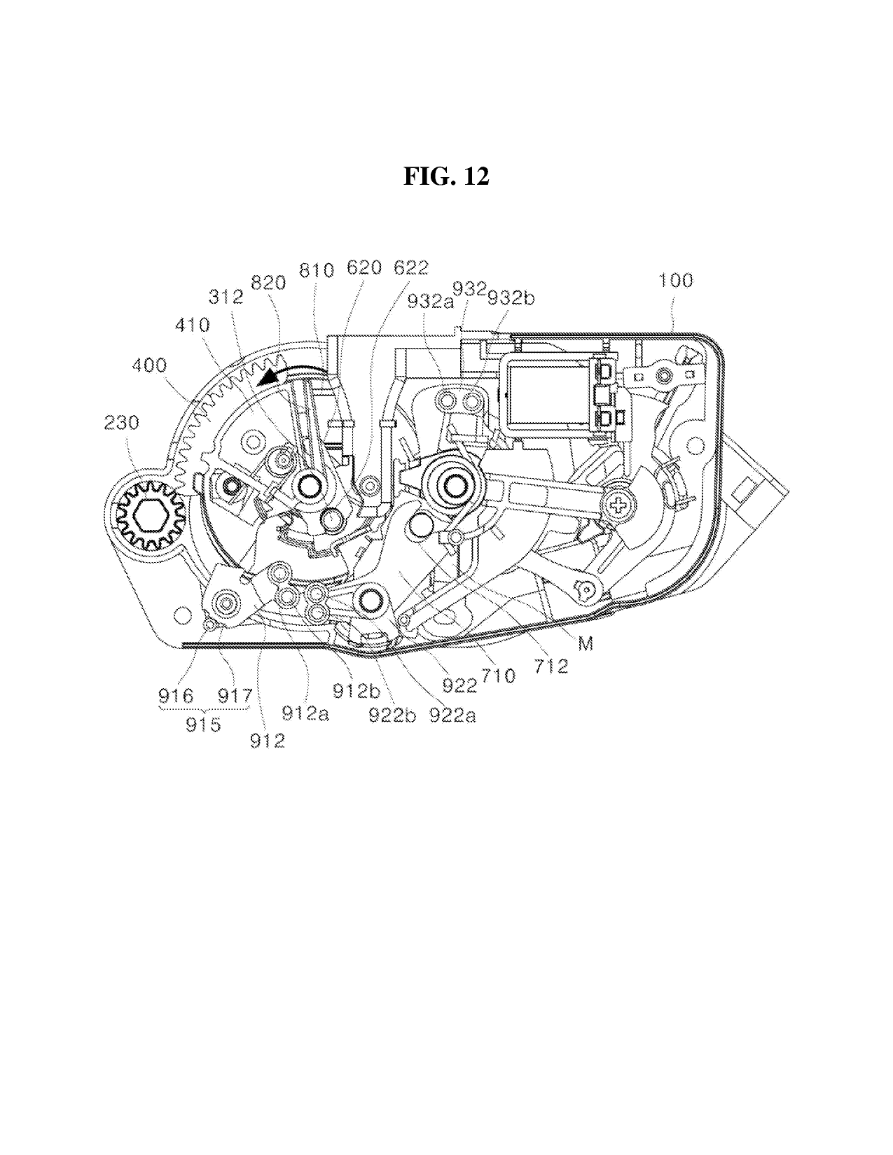

FIG. 12 is a view for describing reconnection of the sector gear unit 400 of the door latch apparatus for a vehicle according to one embodiment of the present invention.

Referring to FIGS. 1 to 6 and 12, the reconnector 800 according to the present embodiment may serve as a component that prevents a malfunction by reconnecting the sector gear unit 400 and the spur gear 230 when the engagement of the sector gear unit 400 and the spur gear 230 is released.

As an example, the reconnector 800 may include a support rib 810 formed on the base 100 and an elastic member 820 provided on the sector gear unit 400 to return the sector gear unit 400 by an elastic force when in contact with the support rib 810.

The sector gear unit 400 may include an operation plate 410. The operation plate 410 may be provided on a front surface of the sector gear unit 400, connected to the sector gear unit 400 and rotated together with the sector gear unit 400.

The support rib 810 may serve as a component that may be formed to protrude from the base 100 to support the elastic member 820 and provide an elastic force when in contact with the elastic member 820.

The elastic member 820 may be formed in the form of an elastic bar formed on the operation plate 410. That is, the elastic member 820 may be formed in a cantilever shape extending radially from the central portion and have a self-elastic force when in contact with the support rib 810. As shown in FIG. 12, when the sector gear unit 400 is rotated clockwise for the cinching operation of the sector gear unit 400 and the engagement of the sector gear unit 400 and the spur gear 230 is released, the elastic member 820 formed of an elastic bar may be in contact with the support rib 810, the operation plate 410 may be elastically moved by the elastic force of the elastic member 820 to rotate the sector gear unit 400 counterclockwise and reconnect the engagement of the sector gear unit 400 and the spur gear 230.

Accordingly, even when the engagement of the sector gear unit 400 and the spur gear 230 is released, it is possible to prevent a malfunction with the reconnection by the elastic member 820.

Although not shown, the reconnector 800 may include the support rib 810 that is formed on the base 100 and applies a repulsive force in a direction opposite to a moving direction of the sector gear unit 400 when in contact with the operation plate 410.

In the present embodiment, the elastic member 820 is shown as an elastic bar formed on the operation plate 410, but is not limited thereto, and various modifications are made possible within the technical scope capable of elastically moving the sector gear unit 400 counterclockwise.

Meanwhile, the door latch apparatus 10 for a vehicle according to one embodiment of the present invention may include a control part 900 for detecting positions of the opening operation unit 500 and the cinching operation unit 600 to detect a malfunction.

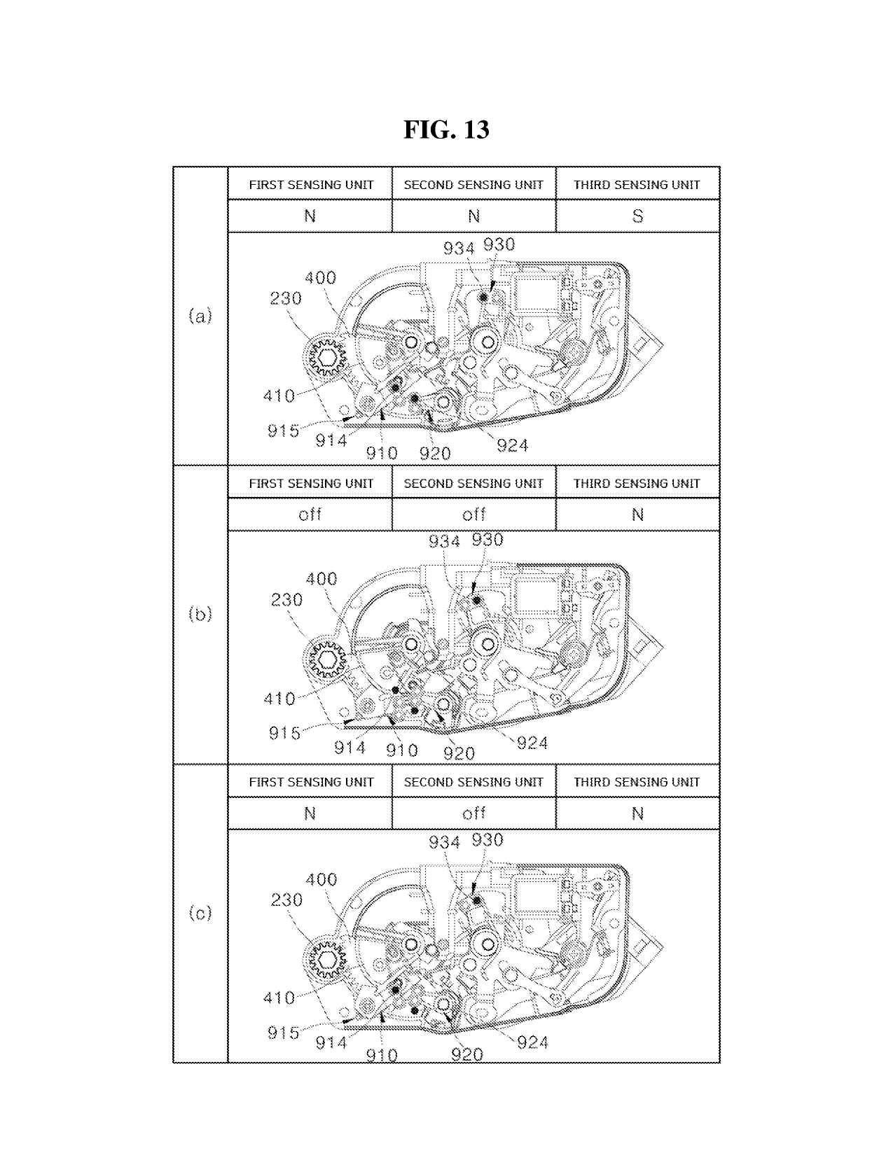

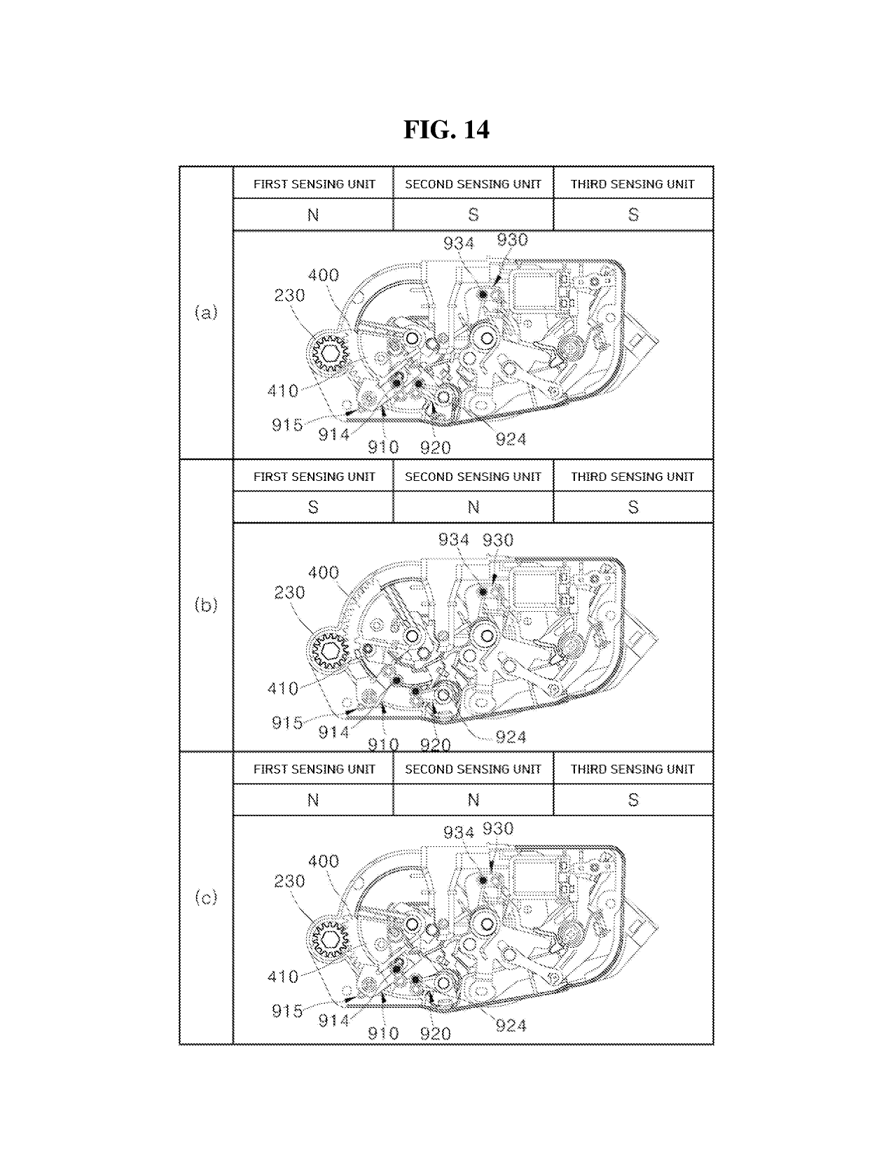

FIG. 13 is a view showing position detection by the power release operation of the door latch apparatus for a vehicle according to one embodiment of the present invention, and FIG. 14 is a view showing position detection by the cinching operation of the door latch apparatus for a vehicle according to one embodiment of the present invention.

Referring to FIGS. 1 to 14, the control part 900 according to the present embodiment may detect positions of the opening operation unit 500 and the cinching operation unit 600 and detect a malfunction of each of the opening operation unit 500 and the cinching operation unit 600.

The control part 900 may include a first sensing unit 910 for detecting a position of the sector gear unit 400, a second sensing unit 920 for detecting a position of the claw 310, a third sensing unit 930 for detecting a position of the pawl 320, and a control unit 940 for determining whether a defect is present based on detection values of the first sensing unit 910, the second sensing unit 920, and the third sensing unit 930.

The first sensing unit 910 may include a first detection lever 912 and a first Hall element 914. The first detection lever 912 is provided to rotate on the base 100. The first detection lever 912 may be provided to correspond to a trajectory centered on a central portion of the sector gear unit 400. Accordingly, the first detection lever 912 may be in contact with the sector gear unit 400. More specifically, the first detection lever 912 may be in contact and rotated with the operation plate 410 formed on the sector gear unit 400.

An end portion of the first detection lever 912 may have magnets of an N pole 912a and an S pole 912b.

In addition, the first Hall element 914 may be provided on the base 100 and correspond to the first detection lever 912. That is, the first Hall element 914 may detect an N pole signal, an S pole signal, and an off signal of the first detection lever 912.

A catch protrusion 412 in contact with the first detection lever 912 may be formed on the operation plate 410 of the sector gear unit 400. Since a front or rear end of the catch protrusion 412 is in contact with the first detection lever 912 depending on the direction of rotation of the sector gear unit 400, the first detection lever 912 may be rotated.

A position of the first detection lever 912 may be fixed by a position fixing unit 915. The position fixing unit 915 may include fixing protrusions 916 formed on the base 100 and a plurality of fixing grooves 917 formed in the same trajectory centered on a rotational axis of the first detection lever 912 to correspond to the fixing protrusions 916.

Since the fixing groove 917 may be formed as three fixing grooves and fixed at three positions by coupling the fixing protrusions 916 to the fixing grooves 917, the first detection lever 912 may be fixed at positions of the N pole signal, the S pole signal, and the off signal detected by the first Hall element 914.

The second sensing unit 920 may include a second detection lever 922 and a second Hall element 924. The second detection lever 922 is provided to rotate on the base 100. The second detection lever 922 may be in conjunction with the rotation of the claw 310, and an end portion thereof may have magnets of an N pole 922a and an S pole 922b. In addition, the second Hall element 924 may be provided on the base 100 and correspond to the second detection lever 922. That is, the second Hall element 924 may detect an N pole signal, an S pole signal, and an off signal of the second detection lever 922.

The third sensing unit 930 may include a third detection lever 932 and a third Hall element 934. The third detection lever 932 is formed on the pawl 320 and has magnets of an N pole 932a and an S pole 932b. In addition, the third Hall element 934 may be provided on the base 100 and correspond to the third detection lever 932. The third Hall element 934 may detect the N pole signal and the S pole signal of the third detection lever 932.

In this way, the positions of the opening operation unit 500 and the cinching operation unit 600 detected by the first, second, and third sensing units 910, 920, and 930 are detected, and the control unit 940 may detect malfunctions based on the positions detected by the first, second, and third sensing units 910, 920, and 930 and display an operating state of the latch apparatus 10 through a display (not shown).

The control unit 940 may be formed of a printed circuit board, and the first Hall element 914, the second Hall element 924, and the third Hall element 934 may be formed in the control unit 940 to correspond to the first detection lever 912, the second detection lever 922, and the third detection lever 932, respectively. Accordingly, it is possible to eliminate a terminal required when a conventional micro switch is applied, thereby improving design flexibility and enhancing assemblability.

Hereinafter, detection of a malfunction of a control part according to the opening operation, cinching operation, and operating state of the door latch apparatus for a vehicle according to one embodiment of the present invention will be described as follows.

First, referring to FIG. 13A, initially, the first Hall element 914 is in a state of detecting the N pole signal of the first detection lever 912, the second Hall element 924 is in a state of detecting the N pole signal of the second detection lever 922, and the third Hall element 934 is in a state of detecting the S pole signal of the third detection lever 932.

Thereafter, when describing the opening operation with reference to FIGS. 7 and 8, the release gear 220 is rotated by the driving force of the motor unit 210, and the sector gear unit 400 engaged with the spur gear 230 is rotated counterclockwise by the rotation of the spur gear 230 rotated together with the release gear 220.

When the operation protrusion 510 is in contact with the power drive lever 520 by the rotation of the sector gear unit 400 to rotate the power drive lever 520, the power drive lever 520 may rotate the pawl 320 to release the engagement of the claw 310 and the pawl 320, thereby opening the latch unit 300. The striker may be separated from the latch unit 300 by opening the latch unit 300, thereby opening the door.

As shown in FIG. 13B, the first detection lever 912 in contact with the operation plate 410 is rotated clockwise by the counterclockwise rotation of the sector gear unit 400, and the first Hall element 914 detects the off signal. In addition, the second detection lever 922 is rotated clockwise by the rotation of the claw 310, the second Hall element 924 detects the off signal, and the third detection lever 932 is also rotated clockwise by the counterclockwise rotation of the pawl 320 to detect the N pole signal.

According to each signal detected by the first Hall element 914, the second Hall element 924, and the third Hall element 934, it may be determined that a correct operation has been performed, and the completion of the opening operation may be currently displayed.

When the opening operation is completed, as shown in FIG. 13C, the first detection lever 912 is also returned to the initial position by returning the sector gear unit 400, and thus the first Hall element 914 detects the N pole signal, the second Hall element 924 detects the off signal, and the third Hall element 934 detects the N pole signal.

Describing the power cinching operation, as shown in FIG. 14A, initially, the first Hall element 914 is in a state of detecting the N pole signal of the first detection lever 912, the second Hall element 924 in a state of detecting the S pole signal of the second detection lever 922, and the third Hall element 934 in a state of detecting the S pole signal of the third detection lever 932. This state is a primarily locked state of the latch unit 300 caused by the entry of the striker.

Thereafter, when the cinching operation is initiated, as shown in FIGS. 9 and 10, the cinching pawl pin 610 may be in contact with the cinching operation lever 620 by the clockwise rotation of the sector gear unit 400, the cinching operation lever 620 may be rotated due to the contact, and the claw 310 may be rotated by the rotation of the cinching operation lever 620 to switch the claw 310 from the primarily locked state to the completely locked state.

As shown in FIG. 14B, the first detection lever 912 in contact with the operation plate 410 is rotated counterclockwise by the clockwise rotation of the sector gear unit 400, and the first Hall element 914 detects the S pole signal. In addition, since the second detection lever 922 is rotated counterclockwise by the rotation of the claw 310, the second Hall element 924 detects the N pole signal, and the third detection lever 932 detects the S pole signal by maintaining the current state of the pawl 320.

When the cinching operation is completed, as shown in FIG. 14C, the first detection lever 912 is also returned to the initial position by returning the sector gear unit 400, and thus the first Hall element 914 detects the N pole signal, the second Hall element 924 detects the N pole signal, and the third Hall element 934 detects the S pole signal.

According to each signal detected by the first Hall element 914, the second Hall element 924, and the third Hall element 934, it may be determined that a correct cinching operation has been performed, and the completion of the cinching operation may be currently displayed.

Meanwhile, according to the present embodiment, the cinching operation can be prevented by the de-clutch function during the cinching operation. This is a function to quickly resolve an accident such as holding by a door, and as shown in FIG. 11, when the de-clutch lever 710 is rotated by the rotation of the manual lever M during the cinching operation by the clockwise rotation of the sector gear unit 400, the curved portion 714 may be in contact with the contact pin 720 to prevent the rotation of the cinching pawl pin 610, thereby preventing the cinching pawl pin 610 from being in contact with the cinching operation lever 620 and preventing the cinching operation. Accordingly, it is possible to prevent the claw 310 from switching from the primarily locked state to the completely locked state. It is possible to prevent safety accidents.

In addition, according to the present embodiment, when the engagement of the sector gear unit 400 and the spur gear 230 is released by excessive rotation of the sector gear unit 400 during the cinching operation, it is possible to prevent disengagement through the reconnector 800.

As shown in FIG. 12, when the engagement of the sector gear unit 400 and the spur gear 230 is released, the elastic member 820 formed of an elastic bar may be in contact with the support rib 810, the operation plate 410 may be elastically moved by the elastic force of the elastic member 820 to rotate the sector gear unit 400 counterclockwise and reconnect the engagement of the sector gear unit 400 and the spur gear 230. Accordingly, even when the engagement of the sector gear unit 400 and the spur gear 230 is released, it is possible to prevent a malfunction with the reconnection by the elastic member 820.

As described above, a door latch apparatus for a vehicle according to the present invention can perform a power release function and a power clinching function by a single driving unit, thereby enabling the light-weight and miniaturization of a door latch apparatus and reducing a manufacturing cost.

According to the present invention, malfunctions of the power release function and the power cinching function can be detected through a plurality of Hall sensors, and an operating state of each function can be displayed, thereby providing convenience.

Although the present invention has been described with reference to embodiments shown in the drawings, these are merely exemplary, and those skilled in the art will understand that various modifications and equivalent other embodiments are possible therefrom.

Accordingly, the true technical scope of the present invention should be determined by the appended claims.

What is claimed is:

1. A door latch apparatus for a vehicle, comprising:
a base;
a driving unit provided on the base;
a latch unit provided on the base to control opening or closing of a door;
a sector gear unit rotated by the driving unit;
an opening operation unit configured to open the latch unit by rotation of the sector gear unit in one direction;
a cinching operation unit configured to switch the latch unit to a completely locked state by rotation of the sector gear unit in the other direction; and
a control part configured to detect positions of the opening operation unit and the cinching operation unit to detect a malfunction.

2. The door latch apparatus of claim 1, wherein the latch unit includes:
a claw provided to be rotatable on the base; and
a pawl that is engaged with the claw and restrains a strike inserted into the claw.

3. The door latch apparatus of claim 2, wherein the opening operation unit includes:
an operation protrusion formed on the sector gear unit; and
a power drive lever that is in contact and rotated with the operation protrusion and rotates the pawl.

4. The door latch apparatus of claim 3, wherein the cinching operation unit includes:
a cinching pawl pin connected to the sector gear unit; and
a cinching operation lever that is in contact and rotated with the cinching pawl pin and moves the claw to a completely locked position when the sector gear unit rotates in the other direction.

5. The door latch apparatus of claim 4, wherein the control part includes:
a first sensing unit configured to detect a position of the sector gear unit;
a second sensing unit configured to detect a position of the claw;
a third sensing unit configured to detect a position of the pawl; and
a control unit configured to determine whether a defect is present based on detection values of the first sensing unit, the second sensing unit, and the third sensing unit.

6. The door latch apparatus of claim 5, wherein the first sensing unit includes:
a first detection lever provided to be rotatable on the base, provided in contact and conjunction with the sector gear unit, and having magnets of N and S poles; and
a first Hall element provided on the base and provided to correspond to the first detection lever.

7. The door latch apparatus of claim 6, wherein the sector gear unit includes an operation plate, and
the operation plate has a catch protrusion formed in contact with the first detection lever.

8. The door latch apparatus of claim 6, wherein a position of the first detection lever is fixed by a position fixing unit, and
the position fixing unit includes:
a fixing protrusion formed on the base; and
a plurality of fixing grooves formed in the same trajectory centered on a center axis of the first detection lever to correspond to the fixing protrusion.

9. The door latch apparatus of claim 5, wherein the second sensing unit includes:
a second detection lever provided to be rotatable on the base, provided in conjunction with rotation of the claw, and having magnets of N and S poles; and
a second Hall element provided on the base and provided to correspond to the second detection lever.

10. The door latch apparatus of claim 5, wherein the third sensing unit includes:
a third detection lever provided to be rotatable on the pawl and having magnets of N and S poles; and
a third Hall element provided on the base and provided to correspond to the third detection lever.
